(19) United States
(12) Patent Application Publication
(10) Pub. No.: US 2014/0128150 A1
(43) Pub. Date: May 8, 2014

(54) DARE MANAGEMENT SYSTEM

(71) Applicant: IPXL, INC., Mountain View, CA (US)

(72) Inventor: Yair Harel, New York, NY (US)

(73) Assignee: IPXL, INC., Mountain View, CA (US)

(21) Appl. No.: 14/075,998

(22) Filed: Nov. 8, 2013

Related U.S. Application Data
(60) Provisional application No. 61/724,224, filed on Nov. 8, 2012.

(51) Int. Cl. A63F 13/00

(52) U.S. Cl. CPC A63F 13/005
USPC 463/25

(57) ABSTRACT

A computer-implemented method and system for managing dares electronically submitted over a computer network. A dare to be issued to a dare recipient is received electronically. A minimum pledge level necessary to guarantee the performance of the dare is indicated by the dare recipient. An electronic monetary pledge in support of the dare is received from at least one dare pledger. Conditions under which the dare must be performed are generated either before or after the minimum pledge level is reached. Electronic proof of the completion of the dare is received from the dare recipient. Permission to view the electronic proof of the completion of the dare is issued to the dare pledger. At least some of the electronic monetary pledge is issued to the dare recipient.

### CROSS REFERENCE TO RELATED APPLICATIONS

This application claims priority to U.S. Provisional Patent Application Ser. No. 61/724,224, filed Nov. 8, 2012, entitled “Dare Management System,” which is hereby incorporated by reference herein in its entirety.

### FIELD OF THE INVENTION

The invention relates generally to a computer implemented, pledge-based system for electronically coordinating and managing the performance of dares and the compensation for such performance.

### BACKGROUND

A “dare” is a challenge issued by a “darer” to a dare recipient or “daree” to perform some stipulated action or stunt. Dares may be motivated by the potential for compensation, such as a financial award, which is given upon the completion of the dare. Dares may involve any action in any category, such as (but not limited to) a physical act, an artistic feat, a business goal, a service, etc.

### SUMMARY OF THE INVENTION

The invention relates generally to the Internet, and more particularly to a computer implemented, pledge-based system for electronically coordinating the performance of dares and the compensation for such performance.

In one aspect of this disclosure, a computer-implemented method and system for dare management is disclosed. A dare to be issued to a dare recipient is received electronically. A minimum pledge level necessary to guarantee the performance of the dare is indicated by the dare recipient. An electronic monetary pledge in support of the dare is received from at least one dare pledger. Conditions under which the dare must be performed are generated either before or after the minimum pledge level is reached. Electronic proof of the completion of the dare is received from the dare recipient. Permission to view the electronic proof of the completion of the dare is issued to the dare pledger. At least some of the electronic monetary pledge may be issued to the dare recipient.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 is a high-level representation of an illustrative dare management system operating on a computer network; and

FIG. 2 is a flow chart of an illustrative sequence of steps for performing management of a dare system on the computer network.

FIG. 3 is a flow chart of an illustrative sequence of steps for performing management of a dare system on the computer network.

### DETAILED DESCRIPTION

This application discloses computer implemented methods and systems for the management of dares and compensation for performance of dares. The computer implemented method and system for the management of dares is implemented on a computer system that is networked to the Internet and/or another computer network. Dare participants, such as dare creators, dare recipients and dare pledgers, may coordinate through the dare management system to participate in the completion of dares. Financial awards, completion requirements and media related to the dare may be coordinated and shared through the system. Furthermore, the financial awards may be divided along percentage lines to dare performers, third party recipients (e.g., charitable organizations), and/or a manager of the computer implemented method and system for the management of dares.

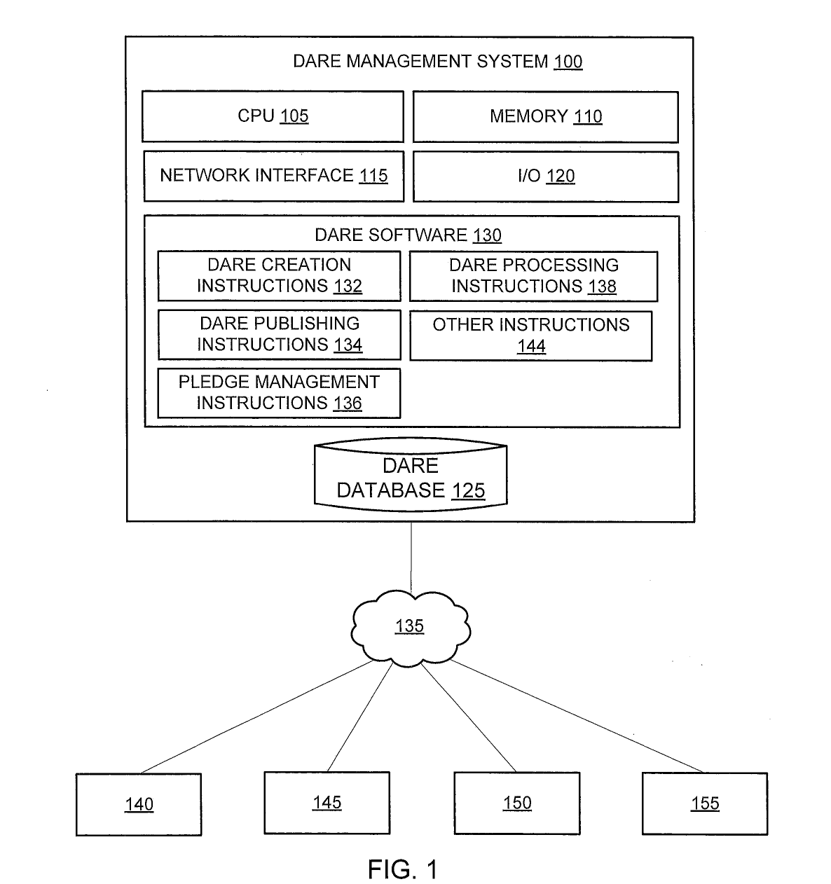

Referring to the Drawings, FIG. 1 is a high-level representation of an illustrative dare management system 100 operating on the Internet 135. The dare management system 100 may be implemented utilizing one or more computing systems of varying configurations. For instance, the computing systems may be combined as a single computing system or as multiple computing systems.

Each computing system preferably includes computing components for executing computer program instructions and processes. These components may include a central processing unit (CPU) 105 (e.g., one or more physical processors), memory 110, input/output (I/O) devices 120, and a network interface 115. The CPU 105 processes and executes computer program instructions. Random access memory (RAM) and/or fast access cache memory 110 preferably provides fast data supply to CPU 115. Long-term storage may be provided as a more permanent form of computer memory, and may be, for example, a hard disk, optical disk, flash memory, solid-state memory, tape, or any other type of memory.

I/O device(s) 120 permit human interaction with the computer system, such as (but not limited to) a mouse, keyboard and computer display. I/O device(s) 120 may also include other interactive devices, such as (but not limited to) touch screens, digital stylus, voice input/output, etc.

The network interface device 115 may provide the computing system with access to a network 135, which may be a wireless or wired connection. The network 135 may be, for example, the Internet, a corporate intranet, or any other computer network through which the computing system may connect to or otherwise communicate with other computers and databases.

The dare management system 100 may also include a dare database 125. The dare database 125 may store information related to dares, such as the dares themselves, identifying information of darers 140, darees 145, pledgers 150 and 155 and/or other relevant parties. Financial information related to pledges may also be stored in the dare database 125.

The dare software 130 may program CPU 105 to perform the functions of dare management system 100. For example, the dare software 130 may include computer program instructions that include dare creation instructions 132 that creates a dare, pledge management instructions 134 that manage pledges associated with the dare, dare publishing instructions 136 that communicate information related to the dare, dare processing instructions 138 that process and update the dare, and/or other instructions 144.

Dare creation instructions 132 may program the CPU 105 to create a given dare based on one or more dare parameters. For example, dare creation instructions 132 may program CPU 105 to receive from a darer a dare request having a particular set of dare parameters. The dare parameters may include, for example, an identification of one or more dare recipients, information that describes the performance that is required of a dare recipient to complete the dare, a time period in which to perform (e.g., complete) the dare, compensation (e.g., pledges) that will be earned upon performance of the dare, a recipient of the compensation, and/or other information that describes the dare. Dare creation instructions 132 may program the CPU 105 to store the dare parameters in dare database 125.

The identification of dare recipients may include a specific identification, a class identification, a public identification and/or other types of identifications that specify one or more dare recipients. The specific identification may identify a particular set of one or more users (who may include an entity such as a corporation or group of individuals). In this manner, the darer may specify particular dare recipients. The class identification may identify a class of individuals (e.g., “executive at Fortune 500 company,” “small business owner,” “professional athlete,” individuals who live/work at a particular geographic region, etc.) that share a common attribute that makes them ideally suited to be the dare recipient. The public identification may identify a general group of dare recipients who may take the dare (e.g., attempt to perform the requirements of the dare). In some implementations (as with certain other dare parameters), the identification of dare recipients may not be specified as a dare parameter. In these implementations, the dare may be open to the public (similar to the public identification).

The performance that is required to complete the dare may include, for example, completion of one or more tasks (e.g., participate in a meeting, create a piece of art, provide a service, make a donation, achieve a certain performance goal, etc.), provision of one or more items (e.g., provide an actual or virtual good), and/or other performance that is required to complete the dare. The time period to complete the dare may include, for example, an absolute time such as (e.g., by a particular date), a relative time (e.g., within one week of acceptance of the dare), a conditional time (e.g., after the occurrence of a conditional event), and/or other time period.

The compensation may include virtual or real monetary compensation, an item, a service, and/or other compensation that may be granted to the dare recipient, a beneficiary of the dare recipient, a third party such as a charity (which may or may not be specified by the dare recipient), and/or other entity that can receive the compensation.

In some implementations, dare creation instructions 132 may program CPU 105 to receive an update or modification to one or more of the dare parameters and accordingly update the dare with the updated dare parameters, thereby changing one or more aspects of the dare. For example, one or more of the dare parameters may be later modified by the darer, the dare recipient, a pledger, and/or other users.

In some implementations, if a dare parameter is modified by the dare recipient, dare creation instructions 132 may program CPU 105 to obtain an acceptance of the modification from the darer. For example, if the dare recipient modifies a condition such as the performance required to complete the dare, the darer may be given an opportunity to accept the modified performance. Changes to other dare parameters may similarly require approval from the darer and/or other users.

In some implementations, dare creation instructions 132 may program CPU 105 to receive from one or more different users, an additional dare parameter that may not have been specified in the original dare request or subsequent updates to the dare. For example, one or more additional dare parameters may be later added by the darer, the dare recipient, a pledger, and/or other users. In this manner, a user may add additional requirements, add a recipient of the compensation, and/or otherwise add a dare parameter that was not included with an original dare or subsequent updates to the dare.

Dare creation instructions 132 may program CPU 105 to update the dare with the additional dare parameters subject to approval by one or more users. For example, if a dare pledger adds a condition such as a recipient of the compensation (e.g., a pledger may wish for at least part of the pledge to be awarded to a particular charity), the darer and/or the dare recipient may be given an opportunity to accept the added condition. Other added dare parameters may similarly require approval from the darer and/or other users.

Dare publishing instructions 134 may program CPU 105 to communicate the dare, including one or more of the dare parameters. In instances where the dare recipient is specifically identified (e.g., via a specific identification or a class identification), the dare may be directly communicated to the dare recipient via electronic mail (“e-mail”), Short Message Service text message, voice, and/or other communication channel where the dare recipient is able to be reached. For example, the darer may specify an e-mail address for a particular dare recipient.

In some implementations, dare publishing instructions 134 may program CPU 105 to provide an interface such as a website, a mobile application interface, and/or other user interface that can communicate the dare. For example, the interface may include a selectable listing of dares that may be publicly viewable. In some implementations, a given dare may be marked private such that only particular users have access to the dare. In these implementations, the dare database 125 may store passwords, obscured URLs, and/or security measures to facilitate private/secure access to the private dares.

Whether the dares are directly communicated to the dare recipient or are publicly or privately viewable, dare publishing instructions 134 may program CPU 105 to provide details of the dare such one or more of the dare parameters, a progress of the performance necessary to complete the dare, and/or other information related to the dare as described herein.

Pledge management instructions 136 may program CPU 105 to manage pledges made by one or more pledgers. The one or more pledgers may include the darer, the dare recipient, third party pledgers, and/or others. Pledges made from users can be the same type of pledge or different types of pledges. For instance, a pledger may pledge a certain monetary amount to contribute toward the compensation while another pledger may pledge an item to contribute to the compensation. In this manner, the compensation may include monetary pledges, pledge items, and/or other types of pledges. Pledge management instructions 136 may keep track of the pledges and keep a running total of the compensation based on the pledges made by one or more users. In some implementations, the pledges made (e.g., the current compensation) may be published so that users are made aware of the current compensation amount. Such publication may encourage other users to also make a pledge toward the compensation amount.

In some implementations, pledge management instructions 136 may program CPU 105 to process a conditional pledge from one or more users. The conditional pledge may predicate a particular pledge upon a condition occurring, such as another pledge being made in a particular amount or quantity. For example, a pledger may commit to pledge a monetary amount only if a total monetary amount is pledged by other users. In another example, a pledger may commit to match (either in whole, in part, or as a multiplier) a given pledge of another user. Other types of conditional pledges may be made as well. In these implementations, pledge management instructions 136 may program CPU 105 to keep track of the conditional pledge and notify the user who made the conditional pledge and/or cause the conditional pledge to become a pledge that is added to the compensation when the condition has been satisfied.

Dare processing instructions 138 may program CPU 105 to process the dare request, which may include receiving an acceptance of the dare from the dare recipient, monitoring the performance of the dare, facilitating the provision of the compensation to the one or more compensation recipients, and/or performing other processing operation related to the dare.

In some implementations, the acceptance of the dare may include a conditional acceptance that is conditioned on the occurrence of one or more events. For example, the conditional acceptance may indicate that the dare is accepted subject to the compensation reaching a particular level. In another example, the conditional acceptance may indicate that the dare is accepted subject to another user co-performing the dare with the recipient and/or performing some other action. In these implementations, dare processing instructions 138 may program CPU 105 to monitor whether the condition has been satisfied to determine whether the dare is accepted.

Dare processing instructions 138 may program CPU 105 to monitor the performance of the dare to determine whether the dare has been performed based on an input from a user and/or automatically. In some implementations, CPU 105 may be programmed to receive, from a user, an input that indicates whether the performance has occurred. For example, if the performance includes a meeting between the dare recipient and a particular user, CPU 105 may be programmed to process an input from the particular user that the meeting has occurred and therefore the dare has been performed. In another example, CPU 105 may be programmed to receive from a dare administrator or other user (e.g., a pledger) an indication that the performance has occurred. The dare administrator or other user may monitor the dare to determine whether the performance has occurred and provide an indication of such performance to CPU 105. In some implementations, CPU 105 may be programmed to automatically determine whether the dare has been performed. For example, CPU 105 may be programmed to poll online resources to determine whether the dare has been performed.

Upon determination that the dare has been performed, dare processing instructions 138 may facilitate transfer of the compensation to the appropriate compensation recipients. For example, for monetary compensation, dare processing instructions 138 may facilitate electronic payments using convention payment processing networks.

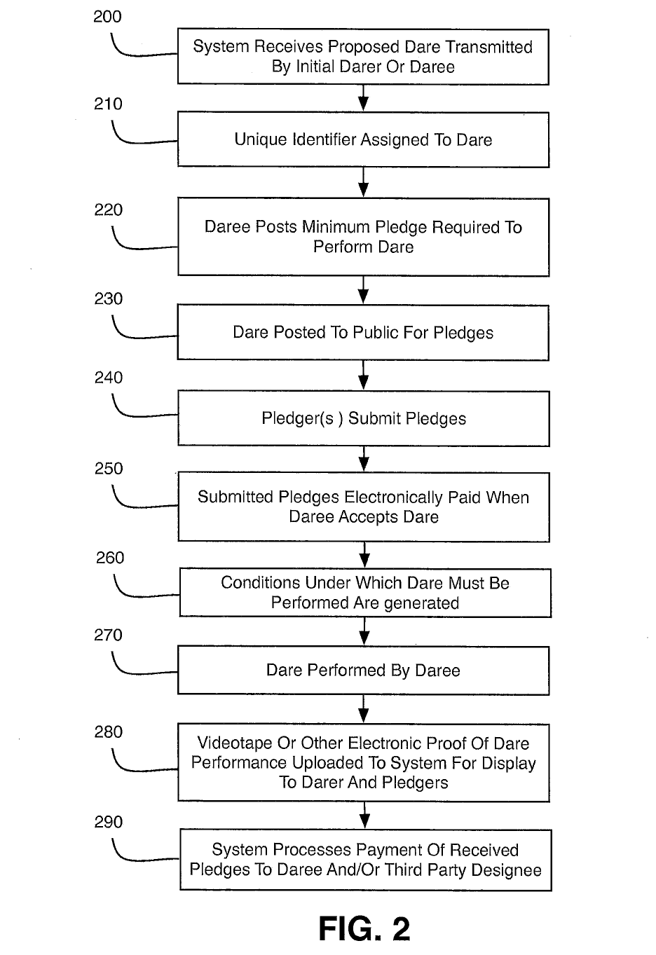

FIG. 2 is a flow chart of an illustrative sequence of steps for performing management of a dare management system 100 on the Internet or other computer network. The dare management system 100 may first receive a proposed dare (Step 200). The proposed dare may be received from a darer 140 (the person issuing a dare) or a daree 145 (the person against whom a dare is issued). The darer and daree may be the same person. The proposed dare is preferably submitted to the dare management system 100 with the name and e-mail of the “initial darer,” or the person creating the dare, the name of the daree 145, the city and state of the daree 145, the description of the dare, and the initial dare's pledge, which is the first monetary pledge to an award issued to the daree if the daree completes the dare. The dare management system 100 may then assign a code to the dare as a unique identifier (Step 210).

The daree may be identified by information including, for example, the daree's 145 first and last name, organizational affiliation (such as employers or educational institutions), and geographic information (such as address information). An alert notifying the daree 145 that it has been dared may be issued by the dare management system 100 using any direct means, such as (but not limited to) e-mail, text message, facsimile, telephone call, etc. Alternatively, social media may be used to disseminate the alerts as well.

Subsequently, the daree 145 (if a different person from the initial darer) may respond by submitting a target minimum total pledge that the daree wants in order to perform the dare (Step 220). The daree 145 may also alter the percentage allocation of the total pledge to other parties, if a portion of the pledge award is to be forwarded to a third party (such as, for example, a charity). The minimum pledge is, however, optional. If there is a percentage of the pledge award to be forwarded to a manager or operator of the dare management system 100, this quantity is preferably non-adjustable. The daree 145 may alternatively choose to leave the minimum pledge open, and declare at a time of his choosing when he is ready to perform the dare. This may be balanced by the ability of pledgers 150-155 to remove their pledges from the dare. If the daree 145 takes too long in completing the dare, financial support may dwindle.

Once the daree 145 submits a minimum pledge to perform the dare or elects to leave the minimum pledge open, the dare management system 100 posts the dare for pledges to the public on a website or by other electronic means. Pledgers 150-155 may then submit pledges to the dare management system 100 that the pledgers are willing to pay if the daree 145 is willing to perform the dare (Step 240).

While the dare is public and pledging is open, pledgers 150-155 may also offer changes to the dare. Preferably, the initial darer may control whether or not the dare should be adjusted to reflect the proposed changes. If a proposed change is not accepted, the proposer may post his alternative dare as a competing dare against the original, and pledgers may shift their pledges in support of one or the other, until the dare is finalized by the managing third party, or a consensus is reached by the pledgers.

Once the daree 145 commits to the performance of the dare, or the minimum pledge level established by the daree is reached, the pledgers 150-155 may electronically transmit payment of the pledged amounts to an account associated with the dare management system 100 (Step 250). Electronic payment may be made using, for example, a credit card or PayPal®.

The logistics or conditions of the dare may be coordinated through the dare management system 100 (Step 260) either before pledges are submitted by pledgers 150-155 or after the daree 145 has committed to the dare. Variables or conditions of the dare, such as (but not limited to) the time, location, aides and other details associated with the dare, may be determined and posted on or generated by the dare management system 100, and thereafter shared with the pledgers 150-155 or other interested parties.

The dare is then performed by the daree 145 at the time and place agreed upon (Step 270) and, preferably, recorded by a third party manager or agent of the dare management system 100. The media recording or other electronic proof of completion of the dare may then be uploaded onto the dare management system 100 (Step 280). The dare management system 100 may limit access to viewing the uploaded media recording to the initial darer 140 and/or pledgers 150-155 who contributed financially to the dare award. Alternatively, the dare management system 100 may broadcast or otherwise permit access for viewing by the public of the uploaded media recording for high visibility dares, such as dares performed by celebrities or widely known people that collect a large number of interested darers or pledgers.

Finally, the dare management system 100 processes payment of the financial award (or a portion of it) to the daree 145, any designated third parties, and any managers of the dare management system 100 (Step 290).

If a daree 145 commits to a dare but fails to perform it, the dare management system 100 may attach a “did not perform” (“DNP”) marker to the daree's account on the dare management system. DNP marks on the system 100 are preferably publicly viewable, and may therefore warn potential pledgers 150-155 and dare initiators 140 of the unreliability of a daree. [0024] Pledgers (or potential pledgers) 150-155 may search for dares to contribute to on the dare management system 100. For example, a website may be hosted on the system 100 with an interface enabling one to browse dares according to any number of searchable categories, including country, city, sex, age group, dare category, popularity, minimum pledge amount, etc. High visibility dares may be specially promoted and featured on a website hosted by the dare management system 100, as well as on social media (e.g., Facebook™, Twitter™, etc.). Receipts may be issued by the dare management system 100 to pledgers 150-155 who have contributed financially to a dare award. The receipt may include information relating to the payment of the pledge, such as the dare identifier, the time and location of payment, and the name of the pledger.

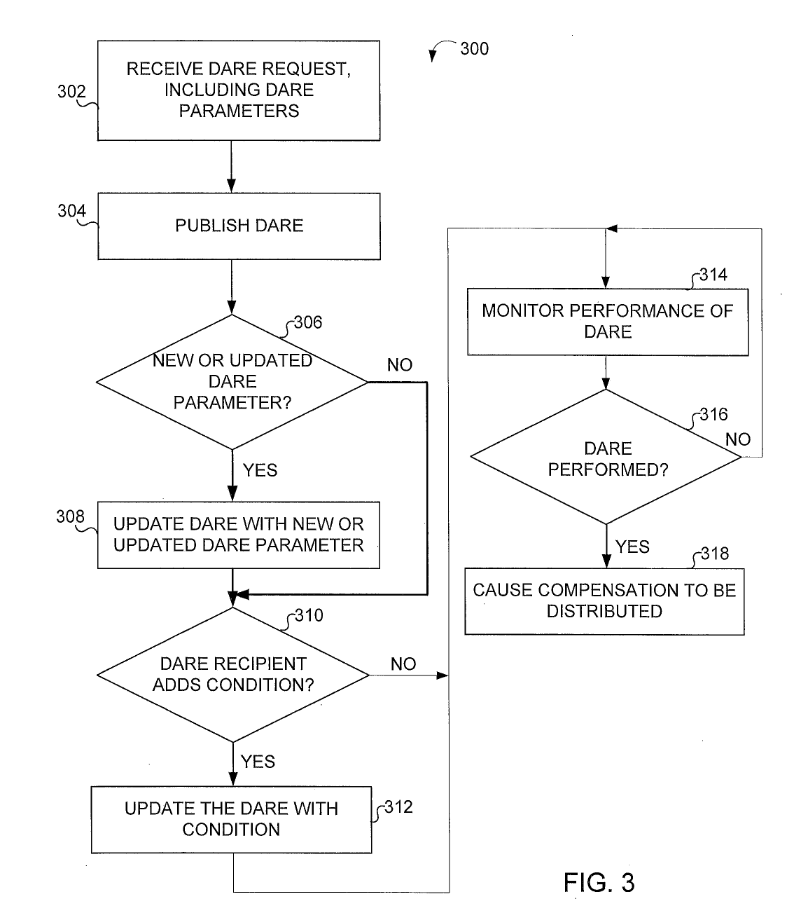

FIG. 3 is a flow chart of an illustrative sequence of steps for performing management of a dare system on the computer network. In an operation 302, a dare request that specifies a dare may be received. The dare request may include one or more dare parameters that describe the dare. In an operation 304, the dare, including at least some of the one or more parameters, may be published. In an operation 306, a determination of whether an update to the dare parameter is received may be made. The update may originate from the darer, the dare recipient, a pledger, and/or other user. If an update is received, the dare may be updated in an operation 308 and any appropriate permission to make the update from another user may be obtained.

In an operation 310, a determination of whether the dare recipient has added a condition to the dare may be made. In the condition has been added, the dare may be modified in an operation 312 and any appropriate permission for such modification may be obtained from one or more other users. In an operation 314, the dare may be determined to be accepted and may be monitored for completion. In an operation 316, a determination of whether the dare has been performed may be made. If the dare has not been performed, processing may return to operation 314, where the dare is monitored. If the dare has been performed, the compensation may be distributed or caused to be distributed to the compensation recipients.

Software process or processes and on the computing system may be used to provide human interfaces (such as a graphical user interface), and to store and initiate computer program instructions used to process and analyze data. Computer program code for carrying out operations described herein may be written in any combination of one or more programming languages, including an object oriented programming language such as Java, C++, C# or the like and conventional procedural programming languages, such as the “C” programming language or similar programming languages. The program code may execute entirely on the computing system, partly on the computing system, as a stand-alone software package, partly on the computing system and partly on a remote computer or server, or entirely on a remote computer or server.

These computer program instructions may also be stored in a computer-readable medium that can direct the computing system to function in a particular manner, such that the instructions stored in the computer-readable medium implement the function/act specified in the flowchart and/or block diagram block or blocks. Any combination of one or more computer usable or computer readable medium(s) may be utilized. The computer-usable or computer-readable medium may be, for example (but not limited to), an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a hard disk, a random access memory, a read-only memory, an erasable programmable read-only memory (e.g., EPROM or Flash memory), an optical fiber, a portable compact disc read-only memory, an optical storage device, a transmission media such as those supporting the Internet or an intranet, or a magnetic storage device. Any medium suitable for electronically capturing, compiling, interpreting, or otherwise processing in a suitable manner, if necessary, and storing into computer memory may be used. In the context of this disclosure, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in base band or as part of a carrier wave. The computer usable program code may be transmitted using any appropriate medium, including (but not limited to) wireless, wire line, optical fiber cable, RF, etc.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed.

What is claimed is:

1. A computer-implemented dare management system, comprising:
a computer processor;
memory comprising program instructions, wherein the program instructions are executable by the processor to:
receive from a dare initiator a dare to be issued to a dare recipient over a computer network;
receive from the dare recipient a minimum pledge level to guarantee performance of the dare;
generate conditions under which the dare must be performed;
receive from at least one dare pledger an electronic monetary pledge in support of the dare;
receive from the dare recipient electronic proof of a completion of the dare;
issuing permission to view the electronic proof of the completion of the dare to the dare pledger; and
issuing at least some of the electronic monetary pledge to the dare recipient.
